(19) United States
(12) Patent Application Publication
(10) Pub. No.: US 2026/0328553 A1
(43) Pub. Date: Oct. 22, 2026

(54) METHOD AND DEVICE FOR DETECTING SHOCK AND VIBRATION STATES IN A MAGNETOSTRICTIVE TRANSDUCER

(71) Applicant: Balluff GmbH, Neuhausen (DE)

(72) Inventors: Zoltán Kantor, Nemesvámos (HU); Attila Szabó, Iszkaszentgyörgy (HU); Tobias König, Esslingen (DE)

(73) Assignee: Balluff GmbH, Neuhausen (DE)

(21) Appl. No.: 19/099,572

(22) PCT Filed: Aug. 16, 2023
(86) PCT No.: PCT/DE2023/200168

§ 371 Date: Jan. 29, 2025

(30) Foreign Application Priority Data
Aug. 29, 2022 (DE) 10 2022 121 751.5

(51) Int. Cl. G01B 7/00

(52) U.S. Cl. CPC G01B 7/003

(57) ABSTRACT

In the method and device described here for operating an electromagnetic, in particular magnetostrictive, sensor or transducer (500), in particular of a position measuring system (500, 505), it is in particular provided that a mechanical shock and/or vibration condition occurring during operation of the sensor/transducer (500) or a vibration of the sensor/transducer (500) caused thereby is detected by evaluating signal fluctuations (120, 125) in the region of a baseline or zero line of a measurement signal provided by the sensor/transducer (500).

### FIELD

The invention relates in general to the operation of a magnetostrictive or magnetostrictively acting sensor or transducer concerned here and, in particular, to a method and a device for detecting shock and/or vibration conditions in a magnetostrictive sensor or transducer, which can be used, for example, in a magnetostrictive position or speed measurement system in the field of technical diagnostics.

### PRIOR ART

Magnetostrictive sensors or transducers can be used in a position measuring system developed and distributed by the applicant in order to determine the position of an object along a sensitive axis of a corresponding sensor device. Such a mostly inductively operating position measuring system (e.g. product number BTL7-V50D-M0250-B-C003 by Balluff GmbH) is designed as a serial sensor device having a planar coil system manufactured using printed circuit board technology. The coil system has an excitation coil and multiple structured planar receiver coils. In order to determine the position of the object relative to the sensor device, the vertical component of the object's magnetic field acting on the coil plane is utilised and metrologically recorded using a magnetostrictive transducer. The amplitude and phase of the induced voltage in each of the receiver coils depends on the position of the object. The measuring range extends to approximately 130 millimetres (mm).

In addition, it emerges from DE 10 2018 129 942 A1 (Balluff GmbH) to provide a vibration sensor in such a sensor device to characterise the operating conditions of a sensor or transducer concerned here. The control of the transducer can use the thus emerging vibration information in order to determine the reliability of recorded sensor data.

Furthermore, an optoelectronic detector for detecting objects in a monitoring region emerges from DE 10 2017 116 828 A1 (Sick AG), which comprises a sensor module having a light transmitter for emitting a transmitted light signal into the monitoring region, a light receiver for receiving a light signal from the monitoring region and for generating a corresponding receiving signal. In addition, a sensor evaluation unit for evaluating the receiving signal and for generating process data (so-called “object determination signal”) and for generating sensor module data is provided. A process data channel serves to output the process data. Furthermore, a condition monitoring module is provided, which has:
a condition evaluation unit for generating condition data,
a first, internal interface between the sensor module and the condition monitoring module for transferring the sensor module data to the condition monitoring module, and
a ring buffer, which receives data, consisting of the condition data and/or sensor module data, from the condition monitoring module via a second interface for temporary storage.

The condition monitoring module is designed to output a first trigger signal via the second interface depending on the condition data and/or the sensor module data, wherein the first trigger signal prevents further overwriting of the data in the ring buffer for a defined period of time, and wherein the data can be output from the ring buffer via a condition data channel. The condition monitoring module is used to detect anomalous behaviour of the sensor data in order to warn of reduced reliability of the sensor system.

### Disclosure of the Invention

The object of the invention is to specify a method and a device for precisely and reliably detecting shock and vibration conditions in a magnetostrictive or magnetostrictively acting transducer concerned here, without requiring costly and technically complex modifications or changes to an existing magnetostrictive transducer and/or a said sensor device having such a transducer.

The idea of the invention is to detect fluctuations caused by a mechanical shock or a resulting vibration in a recorded, preferably amplified measurement or sensor signal of such a sensor device.

Since time measurements based on zero crossings, as are known per se, are relatively inaccurate in such sensor devices and lead to measurement errors in the range of a few millimetres in a position measurement, the proposed method monitors in particular the background noise or a corresponding base/zero line (i.e. ‘baseline’) of the sensor signal in order to reliably detect said disturbances. The sensor signal is preferably digitalised such that this monitoring can be subsequently added to existing sensor devices in the form of a control program or control software.

The present invention is based in particular on the finding that the digitalised signal curve or data points of a corresponding signal waveform calculated from a measurement signal supplied by a measurement sensor concerned here has a characteristic curve in the area of the baseline in a sensor device concerned here in the mechanically undisturbed case. Measurement data, i.e. data points of a said signal waveform, accumulate near the zero line, provided there is no said disturbance due to shock and/or vibration. Therefore, data points present in a zero-centred window can be statistically evaluated and monitored accordingly.

It is worth mentioning here that in the method described here and the device, one or more targets causing a target signal (110) concerned here can be present. The corresponding target signals (110) can therefore appear at any position, so to speak, depending on the position(s) of the underlying targets along the waveguide, e.g. target magnets.

In accordance with the method according to the invention, measurement data which deviate from the aforementioned characteristic course of an undisturbed signal waveform can therefore be characterised as ‘unreliable’, skipped during the evaluation of the measurement data or taken with a lower weighting during further processing or even deleted. Such exclusion, suppression or deletion can be made dependent on whether the deviation of indicator variables of a currently measured signal waveform from corresponding indicator variables of a previously stored, undisturbed signal waveform exceeds an empirically predeterminable measure or, in the case of a scalar indicator variable, an empirically predeterminable threshold value.

It should be noted that the evaluation of the measurement data does not necessarily have to be skipped if a said shock event is detected. This means that a shock/vibration condition can only be recognised when the entire signal curve is already available and it would therefore already be too late to start evaluating the detected signal or signal curve to calculate the position of the target magnet. Therefore, a corresponding waveform recorded under a shock condition does not have to be deleted or completely excluded from the position evaluation.

It should also be noted that a skipping of unreliable measurement data can be implemented when generating position data by means of a sensor device concerned here or a corresponding evaluation/control system. However, the present invention substantially relates to the generation of said indicator values for recognising shock/vibration conditions and their use in the operation of a sensor device concerned here or a corresponding position measuring system.

In the method according to the invention for operating an electromagnetic, in particular magnetostrictive, sensor or transducer, in particular of a position measuring system, it is in particular provided that a mechanical shock and/or vibration condition occurring during operation of the sensor/transducer or a vibration of the sensor/transducer caused thereby is detected by statistical evaluation of signal fluctuations in the region of a baseline or zero line of a measurement signal provided by the sensor/transducer.

In the method according to the invention, a comparison with a characteristic curve of the measurement signal for the undisturbed case is preferably carried out when analysing signal fluctuations in the region of the baseline/zero line.

In the method according to the invention, it can further be provided that the measurement signal is digitalised and the resulting data points are evaluated in a zero-centred, time-limited section or extract of the measurement signal. However, it should be noted that it is preferable not to analyse such sections or extracts, but rather complete waveforms.

In the method according to the invention, it can further be provided that the signal waveform of an undisturbed, electromagnetically effective, in particular magnetostrictive material, is used as the characteristic curve of the measurement signal in the undisturbed case.

In the method according to the invention, it can further be provided that measurement signals or measurement data which deviate from the characteristic curve in the undisturbed case, are excluded from the further processing or are taken with a lower weighting or are deleted.

It can further be provided that measurement signals or measurement data are excluded from the further processing or are taken with a lower weighting or are deleted if the deviation of a currently measured measurement signal or corresponding measurement data exceeds an empirically predeterminable threshold value.

In the method according to the invention, it can further be provided that the deviation of a currently measured measurement signal or corresponding measurement data can be quantified in that relevantly increased values of at least one determined indicator variable are detected in that the at least one indicator variable exceeds an empirically predeterminable threshold value which was determined in advance in the case of undisturbed measurements.

In the method according to the invention, it can further be provided that the evaluation of signal fluctuations in the range of a baseline or zero line of the measurement signal occurs by statistically evaluating data points generated from a measurement signal.

It can further be provided that the statistical evaluation occurs using one or more of the following mathematical evaluation methods, based on waveform data generated from a measurement signal:
“quantile method”, in which the difference between a first and a last quantile (e.g. a quartile) of waveform data is evaluated, which increases under a shock influence;
“histogram method”, which is based on the fact that the sides of a histogram of waveform data close to zero increase at the expense of the centre part, i.e. according to the ratio of sides to centre, under the influence of a shock, and are therefore evaluated according to the ratio of sides to centre;
“standard deviation method”, which is based on the fact that the standard deviation of waveform data close to zero increases under the influence of shock, and thus waveform data close to the baseline/zero line are analysed;
“data density method”, in which the data density of the waveform data near the baseline/zero line is analysed.

In the method according to the invention, it can further be provided that in the case of the histogram method, the number of data points is evaluated depending on the value of a deviation from the zero value.

In the method according to the invention, in particular for operating a magnetostrictive sensor or transducer of a position measuring system having a magnetostrictive or magnetostrictively active or acting waveguide, wherein a mechanical rotational or torsional wave packet is generated in the waveguide by an interrogation current pulse which spreads in both directions along the waveguide, wherein a measuring sensor, i.e. transducer or sensor, arranged near one end of the waveguide is provided for receiving a said measurement signal to convert the rotational/torsional wave packet progressing in the waveguide into an electronic signal, wherein in a first time period of the measurement signal, the interrogation current pulse causes an oscillating interrogation noise and a collective mechanical response of the waveguide caused by the interrogation current pulse in the received measurement signal in the region of the baseline/zero line, and wherein, in a second time interval of the measurement signal, an oscillating background noise and a target signal superimposed on the background noise are present on the interrogation noise in the region of the baseline/zero line, wherein the target signal is followed by a further, oscillating background noise, it can also be provided that, for at least one time range with oscillating noise in the region of the baseline/zero line, measured values of the recorded measurement signal in the at least one time range are compared with corresponding measured values of a sensor/transducer disturbed by a mechanical shock and/or vibration condition and a non-disturbed sensor/transducer and, depending on the result of the comparison, a disturbed or non-disturbed condition of the sensor/transducer is inferred.

In the method according to the invention, it can further be provided that the statistical evaluation is limited to periods of time of the measurement signal which are not influenced by the interrogation noise or the superimposed target signal.

In the method according to the invention, it can finally also be provided that measured values recorded in the at least one time range of a sensor/transducer disturbed by a mechanical shock and/or vibration condition are disturbed by low-frequency noise.

The likewise proposed device according to the invention for operating an electromagnetic, in particular magnetostrictive or magnetostrictively acting, sensor or transducer, in particular of a position measuring system, has in particular an evaluation unit for detecting mechanical shock and/or vibration conditions occurring during the operation of the sensor/transducer or a vibration of the sensor/transducer caused thereby by evaluating signal fluctuations in the region of a baseline or zero line of a measurement signal provided by the sensor/transducer.

The device according to the invention can also have at least one amplifier for amplifying the measurement signal supplied by the sensor/transducer, a comparator for comparing at least one time segment of the amplified measurement signal in the region of the baseline/zero line with a characteristic curve of the measurement signal for the undisturbed case, a time-of-flight analysis unit which supplies a position result, an analogue/digital converter for converting the measurement signal into corresponding digital measurement data, and a statistics unit for statistical evaluation in accordance with the method according to the invention in order to determine or supply a shock indicator variable.

The device according to the invention can also have at least one amplifier for amplifying the measurement signal supplied by the sensor/transducer, at least one analogue/digital converter for converting the measurement signal into corresponding digital measurement data, a digital signal processor for evaluating the measurement data, a time-of-flight analysis unit which supplies a position result, and a statistics unit for statistical evaluation in accordance with the method according to the invention in order to determine or supply a shock indicator variable.

The measurement data from the comparator preferably comes from magnetostrictive ‘time-of-flight’ position sensors. Such sensors have a high degree of measurement inaccuracy due to mechanical shocks and/or vibrations. In the case of relatively large disturbances, a measurement may even be completely impossible due to a resulting lack of zero crossing of data points or due to an invalid precondition with regard to the aforementioned time-of-flight measurement. This is because the application of a cross-correlation technique to a digitalised waveform and the determination of the time of flight from a cross-correlation waveform result in a reduced influence, i.e. a smaller deviation of a determined position of a target object in the present of a vibration or a shock.

By means of the method according to the invention and the device, vibrations and/or shocks in a sensor device concerned here, which influence the accuracy or reliability of a position measurement, can be reliably detected or determined. This means that such sensor devices can also be used reliably in mechanically critical applications.

As a result, the probability of incorrect control interventions or reactions of control systems based on accordingly detected position information is effectively reduced or even completely prevented in the case of position/velocity measurements concerned here. The method and the device also enable a fast pulse-by-pulse display of shock and vibration influences on, for example, an underlying magnetostrictively acting position measuring system. Furthermore, it can be provided that, for example, a corresponding magnetostrictive sensor can report precisely on the exact vibration circumstances during its operation, e.g. in the form of a correspondingly provided condition monitoring function.

When using the method or the device according to the invention in conventional, i.e. comparator-based position measuring systems with magnetostrictive position sensors, only an analogue-to-digital converter system or A/D converter with a low or medium working or clock speed of the converter is required. Such A/D converters are usually already available in common microcontrollers, wherein the implementation of the method according to the invention described in detail below causes a relatively low computing load.

### BRIEF DESCRIPTION OF THE DRAWINGS

Exemplary embodiments of the invention are depicted in the drawings and are explained in more detail in the following description.

It shows:

FIG. 1a-d exemplary measurement curves of a magnetostrictive position measuring system, for the case not disturbed by a mechanical shock pulse (FIG. 1a, c) and the case disturbed by a mechanical shock pulse (FIG. 1b, d);

FIG. 2a-d exemplary waveform data obtained from the measurement curves shown in FIGS. 1a and 1b for evaluation according to the invention using a “quantile” method;

FIG. 3a-d various shock indicator variables according to the evaluation according to the invention, e.g. using histogram depictions;

FIG. 4a, b examples of a designation or non-designation of data points as “unreliable” due to a detected or non-detected shock influence which can be implemented according to the invention; and

FIG. 5a, b five exemplary embodiments of a device according to the invention for implementing the method according to the invention, by means of combined flow/block diagrams, wherein in FIGS. 5a and 5b, identical or similar components are provided with corresponding reference numerals.

### DETAILED DESCRIPTION OF EXEMPLARY EMBODIMENTS

Magnetostrictive position sensor systems typically consist of
a waveguide, which is made of a strongly magnetostrictive material;
an electronic circuit for applying an interrogation current pulse at an initialisation signal to the waveguide itself or to a conductive wire passed through a longitudinal hole of the tubular waveguide to generate a temporary magnetisation of the waveguide;
a target magnet arranged near the waveguide and generating an initial magnetisation of the waveguide, wherein the magnetisation is overwritten by the magnetisation induced by the interrogation current pulse, thereby generating a torsional wave packet spreading in both directions along the waveguide;
a measurement sensor arranged near the near end of the waveguide, i.e. near the electronics of the waveguide, to convert the torsional wave of the waveguide into an electronic signal;
mostly an attenuation zone/structure at the other end of the waveguide to prevent (or attenuate) the reflection of the torsional wave at this end of the waveguide; and an electronic block for evaluating the electronic signal from the measurement sensor.

It should be noted that instead of a conductive or current-carrying wire guided through a longitudinal hole in the tubular waveguide for applying an interrogation current pulse, it can also be provided to pass the excitation current through a (solid) magnetostrictive wire itself and to use a copper wire outside the magnetostrictive wire to conduct the current back to the excitation circuit.

Due to the technical design of such a sensor system, the torsional wave packet and thus the corresponding electronic signal pattern have a typical shape. The time interval measured between the triggering of an interrogation current pulse and the time of detection of a corresponding electronic pattern is used to characterise the position of the target magnet via the correlation between distance and time. The wave propagation speed is used as a proportionality factor between these two points in time. The position detection task is thus transformed into a time measurement task.

In magnetostrictive and also ultrasonic-based position or distance sensors, the measurement technology known per se consists of starting a counter together with the active edge of an ‘Init’ signal, wherein a comparator is provided to detect a level crossing of the electronic output signal of the sensor. The time counter is then stopped when the comparator output is activated. The output of the comparator can be preset or preconditioned by further comparators and sequential logic in order to prevent the counter from stopping due to non-target-related fluctuations, as the microelectronically integrable and highly accurate time counters mostly used here cannot react to false stops without losing valid data.

Due to the coupling with the magnetostrictive waveguide, the electronic signal of the measurement sensor (or “pick-up”) or the sensor signal generated or supplied by the pick-up is exposed to unwanted mechanical interference such as shocks and vibrations that spread along the waveguide to the pick-up zone.

In addition, position measuring systems based on the evaluation of the longitudinal magnetic effect of a torsional wave have become known, which are more sensitive to such disturbances than those using only rotational waves. This is because in the latter systems, the aforementioned disturbances can be coupled into the waveguide from the mechanical environment with much less efficiency.

Within the scope of the solution approach proposed here, it was found that cross-correlation techniques are particularly effective for suppressing the influence of vibrations and shocks on the accuracy of a magnetostrictive position measurement. As the target-related signal component in the position measuring systems concerned here represents a relatively narrow-band wave packet in terms of frequency behaviour, cross-correlation generates efficient filtering of the respectively measured waveform. This is because frequency components near the centre frequency of the waveform, in the order of 100 kHz, can be retained and only the low-frequency components, namely a few kHz, e.g. up to 4 kHZ, which are typical of vibrations and shocks, can be suppressed or excluded when determining the position.

In test investigations, it was found that the undesirable deviation of position data due to external vibration influences in the case of digital determination of a zero crossing time of a cross-correlation waveform is three to ten times less than the deviation resulting from a determination based on an analogue comparator with regard to the zero crossing time of an analogue scanning signal, but cannot be completely eliminated. This is because, in addition to the coupling of the mechanical interference, electronic interference can also cause oscillations in the scanning signal, which can also influence the reliability of the position evaluation.

The starting point for the solution approach described here is to only include or provide information that is relevant for the reliability of the position measurement data generated by the magnetostrictive position sensor under external shock and vibration influences.

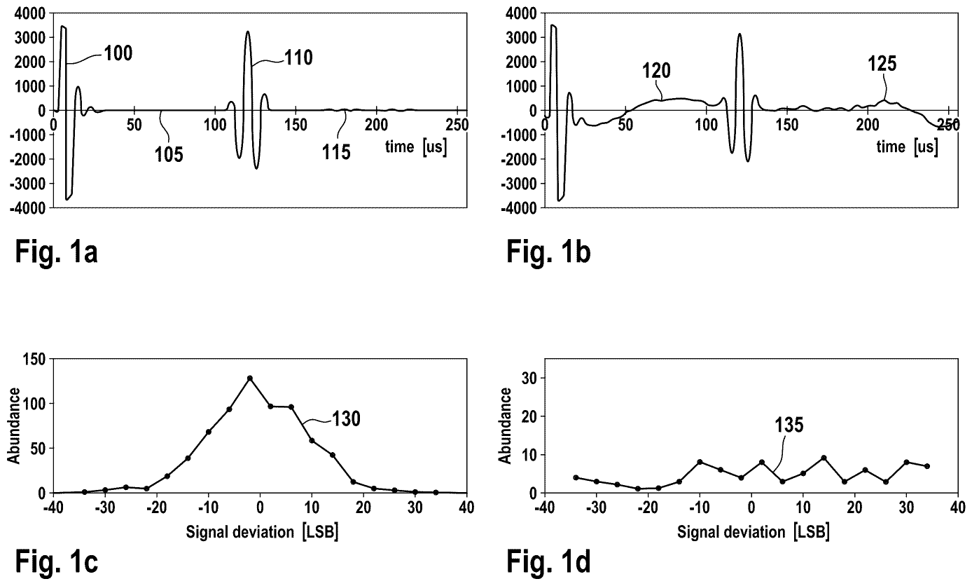

The basis for this information is the structure of the scanning signal. The structure of the measurement signal without the influence of shock is depicted in FIG. 1a. In the diagram, recorded signal values are plotted in the unit [LSB] over time in the unit [μs]. In the underlying measurement, a radially arranged target magnet was used and the waveforms were recorded at a scanning frequency of 3.125 MHz with a nominal resolution of 12 bits. The measurement signal shown in FIG. 1a begins with an oscillating noise 100, which is caused by the approximately 4 μs long interrogation pulse, and the subsequent collective mechanical response of the waveguide that accompanies the interrogation pulse. This disturbance 100 is substantially constant, independent of other influences, and attenuates after approx. 20 μs. This interrogation noise is followed by a section with a background noise 105 close to the zero or baseline and a target signal 110 superimposed on the background noise 105, which appears as a short wavelet between approx. 105 and 135 μs. The target signal 110 is again followed by a background noise 115.

It should be noted that instead of a collective mechanical response of the wave guide associated with the interrogation pulse, an electronic crosstalk from the excitation to the measurement sensor is also possible. The exact structure of such a disturbance signal is not relevant in the present context.

It should also be noted that in the method and the device described here, one or more targets causing a target signal (110) concerned here can be present. The corresponding target signals (110) can thus appear everywhere, depending on the position(s) of the targets. The course of the measurement signal shown is Fig. la is thus only an example and comprises each appearance of such an undisturbed measurement signal, which substantially differs by the actual position of the target, in the case of a magnetostrictive position detection system of a corresponding target magnet.

The shock detection concept described herein becomes clear from the comparison or difference between signal progressions recorded with the undisturbed waveguide (FIG. 1a) and those in which the sensor was subjected to a shock (FIG. 1b).

FIG. 1b again shows a complete waveform as shown in FIG. 1a, i.e. including the interrogation noise and the target signal, wherein the sensor was, however, disturbed by an underlying low-frequency noise 120, 125. In this case, the half-sine shock pulses lasting 2 ms with a maximum value of 150 g, perpendicular to the waveguide, were generated with an electrodynamic shaker. While in the case of the undisturbed waveforms (FIG. 1a), the data points 105, 115 are arranged in the area of the baseline close to the value zero, those of the shock-influenced waveforms 120, 125 deviate considerably from the value zero (FIG. 1b).

This difference also emerges from the respective histograms 130, 135 of the waveform data shown in FIG. 1a and FIG. 1b shown in FIGS. 1c and 1d. In these histograms, the frequency of number of data points (Y-axis) is plotted depending on the value of the respective signal deviation (X-axis) from the value zero. The differences in the two distributions of the waveform data 130, 135 within such a limited data range around the value zero are used in the present case to distinguish whether the respective underlying measurements were carried out under the influence of mechanical shock or not. This distinction is therefore based on such a statistical characterisation of the shock influence.

While the undisturbed and shock-influenced data can be easily distinguished by the distributions 130 and 135 shown in FIGS. 1c and 1d, the evaluation is preferably limited to those sections of the signal form which are not influenced by the interrogation noise or the superimposed target signal. Therefore, by limiting the horizontal axis according to Figures la and 1b to the amount of time required for a torsional wave to spread only once through the magnetostrictive waveguide, it can be effectively prevented that reflections (or echoes) of the torsional oscillation from the ends of the waveguide lead to a further induced signal in the pick-up, which would result in a detrimental spreading of the distribution shown in FIG. 1c. Therefore, in the exemplary embodiments described herein, the aforementioned statistical evaluation of complete waveforms within the running time is applied over a complete length of the waveguide.

In the following, exemplary embodiments of the method or the device according to the invention are described based on various shock detection methods, using the examples of a “quantile method”, a “histogram method” and a “standard deviation method”.

It should be noted that other corresponding or similar detection methods can also be used. However, the four methods mentioned for characterising the reliability of the position measurement data in real time are particularly suitable for enabling a control system of a measurement system concerned here (e.g. position detection system) to effectively prevent incorrect control reactions.

To characterise the actual effect of mechanical disturbances concerned here, the following four evaluation strategies are proposed.

### Example 1:“Quantile Method”

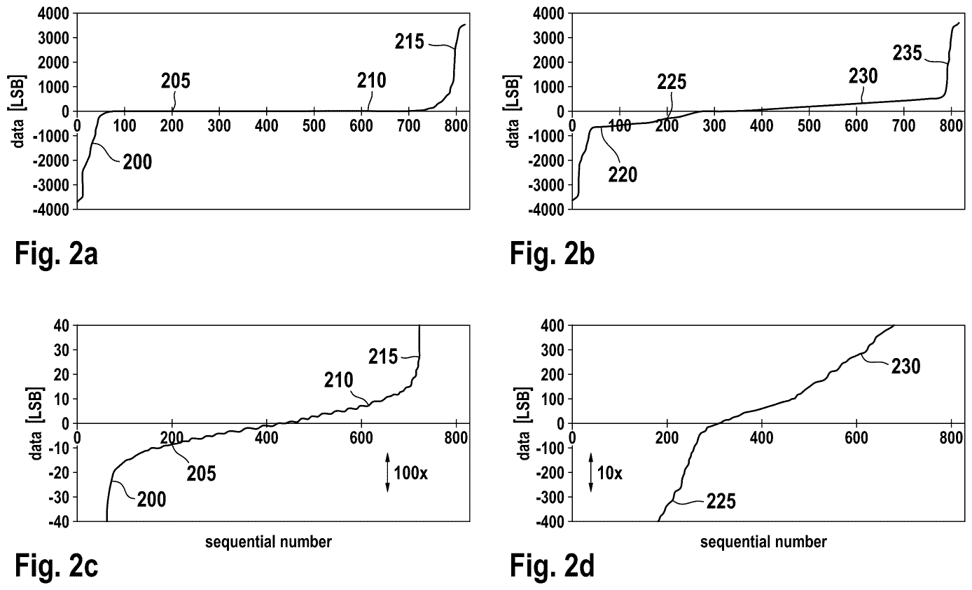

In this method, waveform data elements are sorted in ascending order. The sorted data elements of the waveforms depicted in FIGS. 1a and 1b are depicted in FIGS. 2a and 2b as continuous lines 200, 215 or 220, 235 of the underlying individual data of the detected signals in the unit LSB (LSB=“least significant bit” or “lowest value byte”) as a function of the time. The view of the same data enlarged vertically by a factor of 100 (at least the data labelled 200, 215) is shown in the FIGS. 2c and 2d.

This evaluation method is based on the finding that the waveforms in a disturbance-free measurement signal contain numerous data points around the value zero. Therefore, the statistical number of data points that lie in a narrow value range or window around the value zero must correlate with the strength of the disturbances concerned here.

In this evaluation method, data points, preferably only every nth data point, e.g. 100 data points, are sorted and the difference between the third and first quartile is calculated. With a disturbance-free signal, this difference is small, but increases if the baseline of the signal is disturbed. The use of said quartiles is only preferred, but has the advantages described herein for different lengths of waveguide and for a different number of targets, i.e. for a magnetostrictive measurement system of a different number of target magnets.

It should also be noted that the data elements shown in FIGS. 1a and 1b, for example, of the waveforms are sorted in ascending order, and the waveform values sorted in this way are simply plotted serially, such that the horizontal axis corresponds to the serial number of the sorted waveform data points. The vertical axis is specified in the aforementioned LSB units. The representation of the waveform data in the unit LSB also corresponds to the resolution of the respective analogue-to-digital converter (ADC).

Since most of the data points in the time series of the undisturbed detection signal waveform according to FIG. 1a are arranged close to zero, the gradient of the middle part of the sorted data sequence is small, while the substantially larger deviations 200, 215 and 220, 235 at the two ends of the sorted sequence (FIG. 2c) are caused by the aforementioned interrogation noise and the target signal. In contrast, the data points in the shock-influenced case (FIG. 2d) show an increased deviation due to the mechanical disturbance. In addition, the gradient of the middle part of the sorted sequence is greater due to the wider distribution of the data.

The gradient of the middle part is advantageously characterised by the difference between the first 205 or 225 and the last quantile 210 or 230 of the sorted sequence. As a result, the undisturbed signals are thus characterised by relatively small value differences and the shock-influenced signals are characterised by relatively large value differences. Thus, the differences for the two quantiles marked by the points 205, 210 and 225, 230 in FIGS. 2a-2d have the value 16 LSB in FIG. 2c and the value 600 LSB in FIG. 2d.

With the “quantile method”, the waveform data points can only be sorted if they are available at all. However, using a Field Programmable Gate Array (FPGA), a real-time sorting algorithm can be implemented for a known total data length. The sorting algorithm corresponds to the structure of a one-LSB-per-bin histogram, which consumes a memory area according to the ADC resolution (e.g. 4096 bins for a 12-bit-ADC resolution).

The bin contents can be cumulated from the smallest corresponding ADC values, and if, for example, the fourth of the total number of data points is exceeded, a first “quartile” is found. In statistics, a “quartile” is a type of quantile that divides the number of present data points into four parts or quarters of more or less equal size. The data is ordered from the smallest to the largest value in order to calculate such quartiles, i.e. quartiles are a form of ordinal statistics.

A similar method can be carried out to find a third quartile. In an aforementioned FPGA, both the cumulation and the determination of the quantiles by digital comparison can run in parallel in real time. A histogram-based implementation of the quantile method can also be implemented using microcontrollers, which enables only very short delays.

### Example 2:“Histogram Method”

This method is based on the knowledge gained from the two histograms 130, 135 shown in FIGS. 1c and 1d, namely that the part of the distributions 105, 115 near the zero line, which is characteristic of the undisturbed signals (hereinafter “characteristic curve”), has relatively many data points (FIG. 1c) compared to the peripheral parts, whereas the data points 120, 125 occurring near the zero line are more evenly distributed in the case of shock-influenced signals (FIG. 1d). Thus, in the present example, the peripheral versus mean summation ratio (FIG. 1c) is 0.250, whereas the corresponding summation ratio in the shock-influenced case (FIG. 1d) is 1.471.

With this evaluation method, data points in the lower and upper tertiles of a narrow zero-centred window are counted and added up, and the resulting sum is divided by the number of data points in the middle tertile. The narrow distribution of data points that typically results with an undisturbed signal leads to smaller summation ratios, whereas with disturbed signals, a correspondingly wider distribution of data points leads to larger summation ratios.

Alternatively, the difference in the total summations within the two distributions can also be used. However, for relatively small mechanical disturbances, the total sum is less sensitive than the aforementioned ratio of peripheral to mean sum.

The “histogram method” requires the construction of a three-bin histogram using digital window comparators and, once the required amount of data has been processed, a logical addition component and a logical division component to generate the respective shock indicator parameter.

### Example 3:“Standard Deviation Method” (or “Sigma” Method)

The distribution of the data points near the zero line can also be characterised by their standard deviation. The standard deviation of data points of a signal waveform concerned here is calculated within a narrow, zero-centred window. The narrow distribution of data points typical for an undisturbed signal results in a small sigma value, whereas disturbed signals result in a broader distribution of data points, i.e. corresponding to a larger sigma value.

Thus, according to FIGS. 2c and 2d, the standard deviation of the data points in the range of LSB values between −36 and +36 is approximately 9.5 for the undisturbed case (FIGS. 2c) and 19.9 for the disturbed case (FIG. 2d). It should be noted that without the above restriction to LSB values between −36 and +36, the standard deviation of the data points of the overall waveform would be much less sensitive to the above-mentioned vibration and shock effects due to the large values in the interrogation noise and target signal sections.

The “standard deviation method” requires some logical multiplications as well as the accumulation of some values until the required amount of data is processed. Since the multiplication and accumulation operation can be performed in a single clock on most relevant microcontrollers, this method can be executed as a real-time method on microcontrollers as well as on the aforementioned FPGA architectures.

### Example 4:“Density Method”

The density of data points around zero is calculated by counting data points of a signal waveform affected here in an even narrower window around zero. This is highest for an interference-free signal and decreases when the data points are removed from the vicinity of zero due to ripples in the waveform.

In contrast to the four methods described, other methods are also conceivable in which the spectrum of the measurement signal waveform is calculated and the low-frequency portion of the spectrum is characterised quantitatively, as the effect of shocks and vibrations on a measurement signal affected here normally occurs below 5 kHz. However, the calculation of the spectrum, including by means of a Fast Fourier Transform (FFT) or a Discrete Fourier Transform (DFT), which is limited to the low-frequency range, is relatively computationally intensive and can only be started once the entire waveform has been detected. Such methods are therefore not able to characterise the reliability of actual, i.e. currently available, position measurement data in real time.

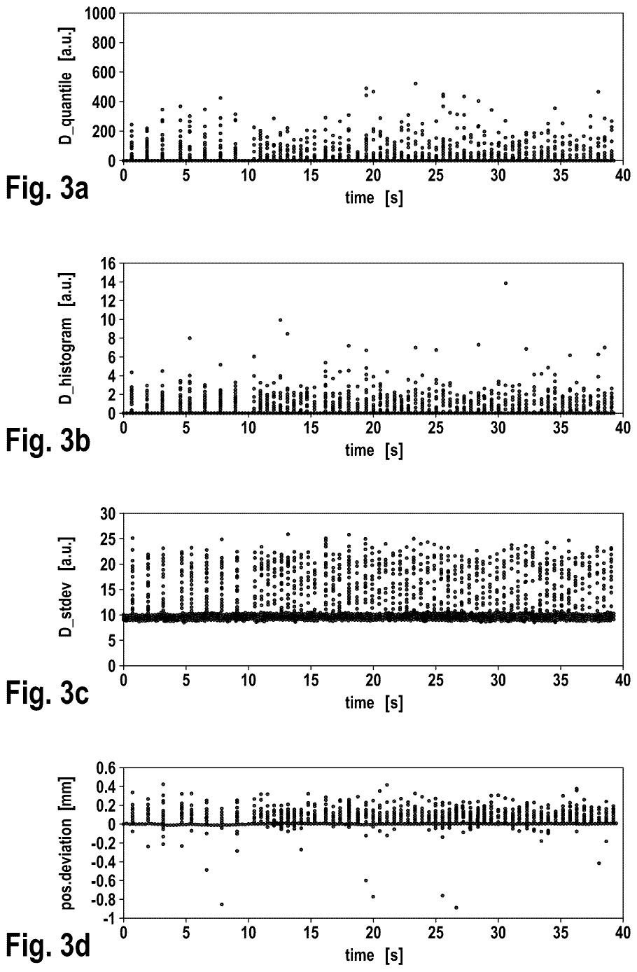

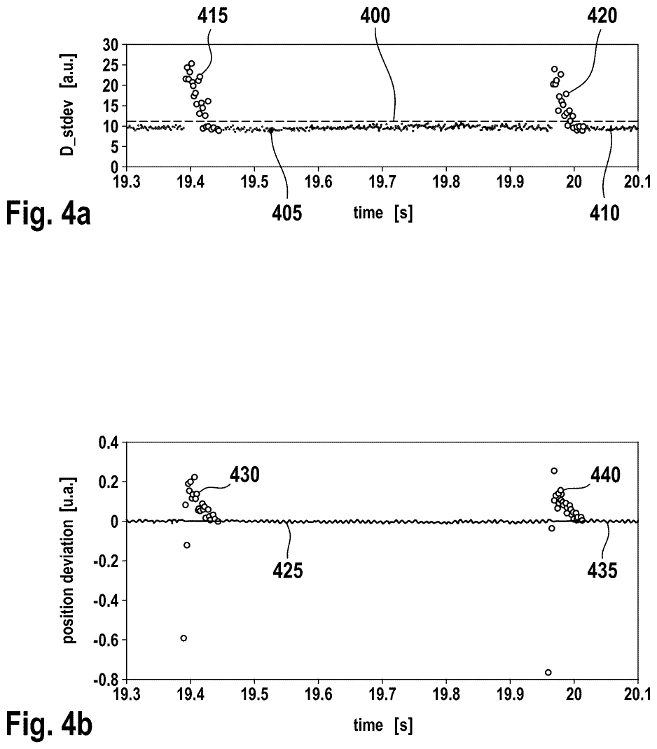

In the following, with reference to FIGS. 3a-3d and FIGS. 4a and 4b, measurement results actually obtained from the above-mentioned position measuring system are described.

A shock pulse as described above was repeatedly applied to a 76 cm long magnetostrictive sensor, while interrogation pulses were output at a repetition rate of 500 Hz and the signal waveforms were recorded at a sampling frequency of 3.125 MHz. For each recorded waveform, the three methods described above were applied to generate different indicator magnitudes for the respective shock behaviour. This method was continued for approximately 40 s, wherein approximately 20,000 waveforms were recorded. In FIGS. 3a-3c, the resulting values of the indicator variables “D_quantile”, D_histogram” and “D_stdev” described above are each plotted in arbitrary units [a.u.] depending on the time t in the unit [s]. In addition, the prescribed deviation “D_&posdev” is plotted against time in [s] in FIG. 3d.

It can be seen from FIGS. 3a and 3d that values of a described indicator variable have increased values above the respective baseline in the time ranges in which shock pulses were present, wherein the baseline has a typical course or a typical, i.e. predetermined value level in the respective undisturbed case. Furthermore, shock pulses have a stochastic effect on both the indicator values and the position deviation. While the indicator values of the disturbed cases are always higher than the values of the undisturbed cases, the position deviation is often even the opposite, i.e. negative, but mostly positive.

It should also be noted that there appears to be no correlation between any two of the indicator values described and also no correlation between an indicator value and the position deviation.

The position of the target magnet can be calculated from the signal behaviour recorded in this way. First, the cross-correlation between a reference waveform and the detected waveform is calculated, wherein the reference waveform was previously recorded by taking a limited time period with target influences of an undisturbed signal waveform as shown in FIGS. 1a-d and 2a-d as a basis. The target position is defined, without reference to an unavoidable constant offset value, as the location of the first negative zero crossing of the cross-correlation waveform and is calculated by linear regression to the data over this zero crossing. A corresponding deviation of the position values from the main position calculated for undisturbed measurements is depicted in FIG. 3d.

It should be noted here that the effect of the shock lasts much longer than the 2 ms shock pulse itself. Furthermore, the deviation of the position data to its undisturbed value relaxes later than the subsidence of the shock indicator variables, which can essentially be attributed to real target vibrations despite the damping of the vibration of the sensor waveguide itself.

The effects of shock-like vibrations, e.g. on a position measurement, can be quantified by recognising relevantly increased values of the aforementioned indicator parameters for this measurement when at least one of the shock indicator variables exceeds an empirically predeterminable threshold value that was previously determined during vibration-free measurements. Alternatively or additionally, several such variables obtained under unknown vibration conditions can be analysed.

FIGS. 4a and 4b depict an example of marking or labelling or non-marking or non-labelling of data points as “unreliable” due to a detected shock influence, which can be carried out automatically using the method described.

FIG. 4a shows a shock indicator value according to the “standard deviation method” for the time span of a position measurement, in this case for a period of 0.8 s. In the diagram shown, the indicator variable “D_stdev” 405, 410, again in arbitrary units [a.u.], is plotted over the time t in [s]. The circles 415, 420 shown in FIG. 4a show those data points that were classified as unreliable using the following method and labelled accordingly:

At a point in time when the shock indicator value exceeds a predefined threshold value 400 (depicted as a dashed line in FIG. 4a), the corresponding position output data is marked or labelled as unreliable. These markings are maintained for an empirically predeterminable period of time after the recorded shock indicator values have fallen below the predefined level 400 again. During this period, further measuring points or corresponding data points continue to be marked or labelled, namely ten (10) further measuring points in the present exemplary embodiment. In FIG. 4a, data not labelled in the aforementioned manner are shown as small dots.

The corresponding position data 425, 435 are depicted in FIG. 4b. Both the threshold value 400 for marking/labelling shown in FIG. 4a and the number of output data for which the marking/labelling is maintained can be determined empirically according to the required dynamics of the overall system. While a relatively low threshold value and a relatively long duration for marking/labelling lead to more reliable output data and thus to a more stable position measuring system, such values also reduce the possible dynamics of the control system.

It should be noted that the shock-induced zero-point fluctuations shown in FIG. 4a last longer than the underlying shock event itself. As can be seen from FIG. 4b, the shock-induced fluctuations 430, 440 of the position data resulting from the measurement shown in FIG. 4a last even longer than the recorded fluctuations of the indicator variable “D_stdev” shown in FIG. 4a. It should also be noted that that the data points of the corresponding signal waveforms derived from the measurement data can also be adjusted for the data points labelled as unreliable, i.e. they can be completely deleted, for example.

It should be noted that the sensor-recorded measurement data itself is not labelled as “unreliable” or even completely deleted. Only the digital signal waveforms derived from the measurement data or the position data resulting from the evaluation can be labelled as “unreliable”. Unreliable position data can also be suppressed by exclusion using adaptive filtering, e.g. using a Kalman filter or by appropriate weighting.

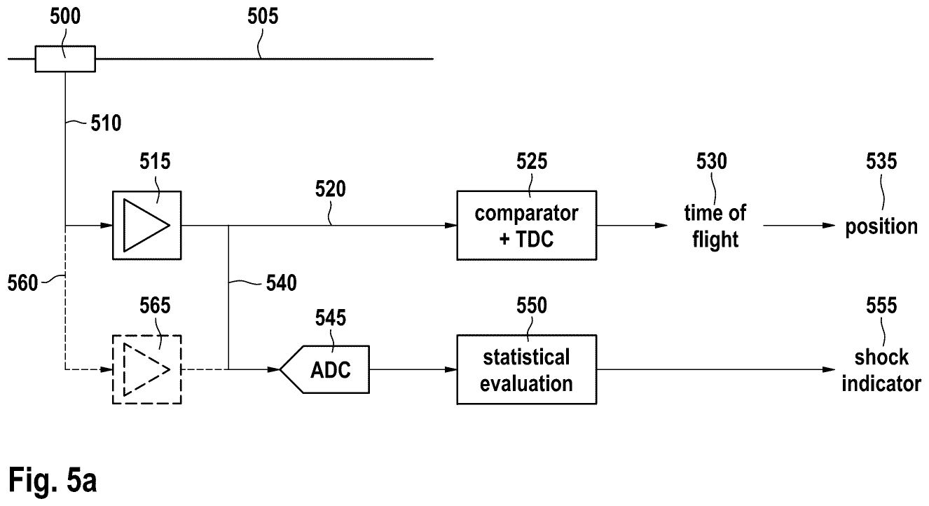

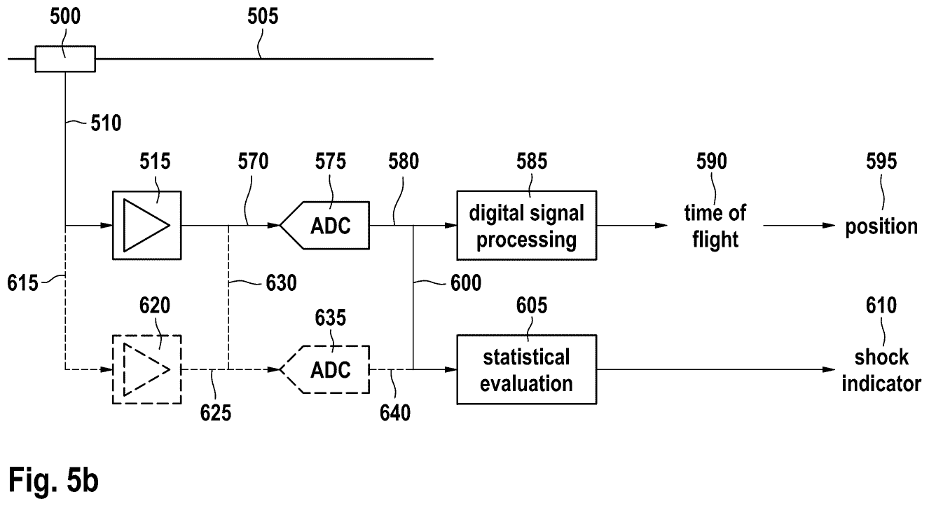

Exemplary embodiments of a device for implementing the method described above are depicted in FIGS. 5a and 5b using combined flow/block diagrams.

The method and the device for generating shock indicator values are based on the digitalisation of the respective sensor signals. However, the device for detecting a target position and for the parallel generation of reliability information for recorded position data described above, in particular for generating a shock indicator value described above, can be implemented in different ways.

FIG. 5a shows two exemplary embodiments of an aforementioned device, with and without the additional dashed components.

According to the first exemplary embodiment of the device, the signals to be analysed are supplied by a measurement sensor (“pick-up”) 500 which is arranged near the near end of a magnetostrictive waveguide 505, i.e. near the electronics of the waveguide. Via a first line 510, these signals are fed to a first amplifier 515 in order to raise the signal level to a variable that can be further processed. The signal amplified in this way is fed via a second line 520 to a comparator (with integrated TDC in the present case) 525, in which the comparison described above is carried out. The data resulting from this processing step is then fed to a time-of-flight analysis 530, which provides a position result 535.

It should be noted here that the evaluation of waveform data derived from the measurement data does not have to be terminated or interrupted if a shock event concerned here is detected. A shock/vibration condition can only be detected when the entire signal curve is already available and it is therefore too late to start evaluating the signal/signal curve to calculate the position of the target magnet. Therefore, a corresponding waveform recorded under a shock condition does not have to be deleted or completely excluded from the position evaluation.

Incidentally, this also applies to a comparator-based runtime measurement shown in FIG. 5a, in which a comparator and a “time-to-digital” converter have already generated position data. In the lower evaluation path shown in FIGS. 5a and 5b, indicator values are calculated from the signal waveforms, and based on the indicator values and their comparison with a threshold value, the position data can be labelled as unreliable.

Via a third line 540 branching off from the second line 520, the amplified signal is additionally fed to an ADC 545, the digital output signal of which is fed to a statistics unit 550 for the aforementioned statistical evaluation of said waveform in order to determine or supply a shock indictor variable 555 as a result.

In the second exemplary embodiment of the device depicted with dashed lines, the signal supplied by the measurement sensor 500 is fed to a second amplifier 565 via a fourth line 560 and only then to the ADC 545. In the second exemplary embodiment, the third line 540 thus becomes obsolete or is not arranged. This enables the amplification factors or corresponding level increases of the signals supplied by the measurement sensor 500 to be selected differently for further processing by the comparator 525 and by the ADC 545 or the subsequent statistical evaluation 550, in order to be able to provide suitable or optimum signal levels for the two separate further processing steps 525-535 or 550, 555.

FIG. 5b shows three further exemplary embodiments of an aforementioned device, with and without the additional dashed components. In these exemplary embodiments too, the measurement signals supplied by the measurement sensor (“pick-up”) 500 arranged at one end of the magnetostrictive waveguide 505 are fed to a first amplifier 515 via the first line 510.

In the third exemplary embodiment, the amplified signal is fed via a second line 570 to a first ADC 575, in which the amplified signal is first digitalised. The digital signal or the corresponding data is or are fed via a third line 580 both to a digital signal processor 585 and via a branching fourth line 600 in turn to a statistics unit 605 for the aforementioned statistical evaluation of an aforementioned waveform.

The data supplied by the digital signal processor 585 after evaluation is fed to a time-of-flight analysis 590, which in turn supplies a position result 595.

The evaluation results supplied by the statistics unit 605 then in turn supply a shock indicator variable 610 described above.

In the fourth exemplary embodiment of the device depicted with dashed lines in FIG. 5b, the amplified signal supplied by the first amplifier 515 is fed to a second ADC 635 via a branching, additional fifth line 630. This enables, for example, the parameters for analogue-to-digital conversion to be selected differently for the respective subsequent components, i.e. the digital signal processor 585 and the statistics unit 605. The digitalised signal or the corresponding digital data is fed to the statistics unit 605 via a sixth line 640 for the purpose described.

In the fifth exemplary embodiment of the device, additionally depicted with dashed lines in FIG. 5b, the measurement signal supplied by the measurement sensor 500 via the first line 510 is additionally fed to a second amplifier 620 via a branching seventh line 615 and only then via an eighth line 625 to the second ADC 635 present in accordance with the fourth exemplary embodiment. This in turn enables the amplification factors or corresponding level increases of the signals supplied by the measurement sensor 500 to be selected differently for further processing by subsequent further processing in the digital signal processor 585 and in the statistics unit 605 connected via the sixth line 640, in order to be able to provide suitable or optimum signal levels for these two separate further processing steps 585-595 or 605, 610.

It should also be noted that in the fourth exemplary embodiment, the fourth line 600 is obsolete and in the fifth exemplary embodiment, both lines 600, 630 are obsolete.

According to the exemplary embodiments shown in FIGS. 5a and 5b, the evaluation 530 of the runtime of the target signal for determining the target position 535 can be performed both by means of a high-resolution time-to-digital converter 525 and by generating a stop input signal by means of an analogue zero comparator for the pre-amplified detection signal. This involves a digital evaluation of the respective detected waveform, which is generated by digitalising the detection signal.

As can also be seen from FIGS. 5a and 5b, the requirements for both the signal amplifier and the respective analogue-to-digital converter (ADC) 545, 575, 635 and its parameters for generating shock indicator values can differ from those required for evaluating the runtime. Thus, the evaluation can be performed either by the comparator 525, possibly combined with an aforementioned “time-to-digital” converter (TDC 525), or by digital signal processing using a digital signal processor.

As only values close to zero are relevant for shock detection, as described above, it is advantageous to apply higher amplifications-regardless of the saturation of the target-influenced section of the signal. On the other hand, the calculation of the shock indicator values does not require high-resolution or precise analogue-to-digital converters, in contrast to the case where the runtime is determined from the digitalised signal behaviour by digital signal processing. Furthermore, since the shock indicator values are calculated by each method by statistical methods and the signal bandwidth of the shock and vibration related signal components is small, the scanning frequency of the associated ADC 545, 575, 635 is also not time critical.

It should finally be noted that the method described above can be realised in a conventional, comparator-based, magnetostrictive position measuring system or in a purely software-based magnetostrictive position measuring system based on the evaluation of a signal waveform described above.

What is claimed is:

1. Method for operating an electromagnetic, in particular magnetostrictive; sensor or transducer, in particular of a position measuring system, characterised in that a mechanical shock and/or vibration condition occurring during operation of the sensor/transducer or a vibration of the sensor/transducer caused thereby is detected by statistical evaluation of signal fluctuations (120, 125) in the region of a baseline or zero line of a measurement signal provided by the sensor/transducer.

2. Method according to claim 1, characterised in that, during the evaluation of signal fluctuations in the region of the baseline/zero line, a comparison is made with a characteristic curve of the measurement signal for the undisturbed case.

3. Method according to claim 2, characterised in that the measurement signal is digitalised and resulting data points of a corresponding signal waveform are evaluated in a zero-centred, time-limited section the measurement signal.

4. Method according to claim 2, characterised in that the signal waveform of an undisturbed, electromagnetically effective, in particular magnetostrictive material is used as the characteristic curve of the measurement signal in the undisturbed case.

5. Method according to claim 3 characterised in that signal waveforms which deviate from the characteristic curve in the undisturbed case are labelled as “unreliable” and/or are excluded from further processing or are given a lower weighting or are deleted.

6. Method according to claim 5, characterised in that signal waveforms are excluded from the further processing or are given a lower weighting or are deleted if the deviation of a currently recorded signal waveform exceeds an empirically predeterminable threshold value at least one determined indicator variable.

7. Method according to claim 6, characterised in that the deviation of a currently measured signal waveform is quantified in that relevant increased values of at least one determined indicator variable are detected in that the at least one indicator variable exceeds an empirically predeterminable threshold value which was determined in advance in the case of undisturbed measurements.

8. Method according to claim 2, characterised in that evaluation of signal fluctuations in the region of a baseline/zero line of the signal waveform occurs by means of statistical evaluation of data points generated from a signal waveform.

9. Method according to claim 8, characterised in that the statistical evaluation takes place using one or more of the following mathematical evaluation methods, on the basis of data points of a corresponding signal waveform generated from a measurement signal:
“quantile method”, in which the difference between a first and a last quantile (e.g. a quartile) of data points of the signal waveform is evaluated;
“histogram method”, in which the sides of a histogram of data points of the signal waveform close to the value zero are evaluated according to the ratio of sides to centre;
“standard deviation method”, in which the standard deviation of data points of the signal waveform close to the baseline/zero line are analysed;
“data density method”, in which the data density of data points of the signal waveform near the baseline/zero line are analysed.

10. Method according to claim 9, characterised in that, in the histogram method, the number of data points is evaluated depending on the value of a deviation from the value zero.

11. Method according to claim 1 for operating a magnetostrictive sensor or transducer of a position measuring system having a magnetostrictive waveguide wherein a mechanical rotational or torsional wave packet is generated in the waveguide by an interrogation current pulse which propagates in both directions along the waveguide, wherein a measuring sensor arranged near one end of the waveguide is provided for receiving a said measurement signal to convert the rotational/torsional wave packet progressing in the waveguide into an electronic signal, wherein in a first time period of the measurement signal, the interrogation current pulse causes an oscillating interrogation noise and a collective mechanical response of the waveguide caused by the interrogation current pulse in the received measurement signal in the region of the baseline/zero line, and wherein, in a second time interval of the measurement signal, an oscillating background noise and a target signal superimposed on the background noise are present on the interrogation noise in the region of the baseline/zero line, wherein the target signal is followed by a further, oscillating background noise characterised in that, for at least one time range with oscillating noise in the region of the baseline/zero line, measured values of the recorded measurement signal in the at least one time range are compared with corresponding measured values of a sensor/transducer disturbed by a mechanical shock and/or vibration condition and a non-disturbed sensor/transducer and, depending on the result of the comparison, a disturbed or non-disturbed condition of the sensor/transducer is inferred.

12. Method according to claim 11, characterised in that the statistical evaluation is restricted to time intervals of data points of a signal waveform which are not influenced by the interrogation noise or the superimposed target signal.

13. Method according to claim 11, characterised in that measured values recorded in the at least one time range of a sensor/transducer disturbed by a mechanical shock and/or vibration condition are disturbed by low-frequency noise.

14. Device for operating an electromagnetic, in particular magnetostrictive, sensor or transducer, in particular of a position measuring system, characterised by an evaluating unit for detecting any mechanical shock and/or vibration conditions occurring during operation of the sensor/transducer or any vibration of the sensor/transducer caused thereby by evaluating signal fluctuations in the region of a baseline or zero line of a measurement signal provided by the sensor/transducer.

15. Device according to claim 14, characterised by at least one amplifier for amplifying the measurement signal supplied by the sensor/transducer, a comparator for comparing at least one time interval of the amplified measurement signal in the region of the baseline/zero line with a characteristic curve of data points of a signal waveform for the undisturbed case, a time-of-flight analysis unit, which supplies a position result, an analogue/digital converter for converting the measurement signal into digital data points of a corresponding signal waveform, and a statistics unit for statistical evaluation in accordance with claim 1, in order to determine or supply a shock indicator variable.

16. Device according to claim 14, characterised by at least one amplifier for amplifying the measurement signal supplied by the sensor/converter, at least one analogue/digital converter for converting the measurement signal into data points of a corresponding signal waveform, a digital signal processor for evaluating the measurement data, a time-of-flight analysis unit, which supplies a position result, and a statistics unit for statistical evaluation in accordance with claims 1, in order to determine or supply a shock indicator variable.
